(19) United States
(12) Patent Application Publication
(10) Pub. No.: US 2021/0364297 A1
(43) Pub. Date: Nov. 25, 2021

(54) DYNAMIC ROUTE PLANNING METHOD AND DEVICE FOR UNMANNED SHIP USED FOR FEEDING

(71) Applicant: Wuyi University, Jiangmen (CN)

(72) Inventors: Jingling ZHANG, Jiangmen (CN); Keshuo Chen, Jiangmen (CN); Tao Ou, Jiangmen (CN); Tianlei Wang, Jiangmen (CN); Yujie Zheng, Jiangmen (CN); Feilong Hou, Jiangmen (CN); Yingjian Wu, Jiangmen (CN)

(21) Appl. No.: 16/944,611

(22) Filed: Jul. 31, 2020

(30) Foreign Application Priority Data
May 20, 2020 (CN) 2020104304285

(51) Int. Cl. G01C 21/20; B63B 35/00

(52) U.S. Cl. CPC G01C 21/203; B63B 2213/02; B63B 2035/007; B63B 35/00

(57) ABSTRACT

Disclosed are a dynamic route planning method and device for unmanned ship used for feeding. The method includes: acquiring positioning information of a first set of vertices in a water body region, a feeding distance of a feeding device and positioning information of an unmanned ship; establishing a regional model according to the positioning information of the first set of vertices, and obtaining a route planning point according to the regional model and the feeding distance of the feeding device; obtaining a route target point according to the positioning information of the first set of vertices and the route planning point; dividing the route target point into an unreached target point or a reached target point according to the positioning information of the unmanned ship and the route target point; and obtaining a cruise route according to the positioning information of the unmanned ship and the unreached target point.

### CROSS-REFERENCE TO RELATED APPLICATIONS

This application is based on and claims the benefit of priority from Chinese Patent Application No. 2020104304285 filed on 20 May 2020, the entirety of which is incorporated by reference herein.

### TECHNICAL FIELD

The present disclosure relates to the field of unmanned ship route planning technologies, and more particularly, to a dynamic route planning method and device for unmanned ship used for feeding.

### BACKGROUND

Currently, China has a very large aquaculture area and a wide range of aquaculture species. Moreover, intensive and large-scale aquaculture is developed at an accelerating speed, thus putting forward new demands for an aquaculture method, and automated and intelligent aquaculture is an inevitable trend of development. Most aquaculture ponds are mainly outdoor ponds currently, and feeding and other works are necessary to these ponds during aquaculture. For large-scale ponds, an unmanned ship needs to be used for automatic feeding. At present, a cruise route needs to be generated for the unmanned ship before cruising, but when the unmanned ship deviates from the preset cruise route due to various factors, the route is unable to be re-planned, resulting in that the unmanned ship is unable to enter a feeding region of a deviated part according to the formulated cruise route, and the unmanned ship is unable to perform completely covered feeding, so that an output and a benefit are reduced.

### SUMMARY

The present disclosure is intended to address at least one of the technical problems in the existing art, and provides a dynamic route planning method and device for unmanned ship used for feeding, so that a cruise route with a shortest distance is able to be dynamically generated after an unmanned ship deviates from a preset cruise route due to various factors.

The solutions used in the present disclosure to address the technical problem thereof are as follows.

On the first aspect, the present disclosure provides a dynamic route planning method for unmanned ship used for feeding, which includes:

acquiring positioning information of a first set of vertices in a water body region, a feeding distance of a feeding device and positioning information of an unmanned ship;

establishing a regional model according to the positioning information of the first set of vertices, and obtaining a route planning point according to the regional model and the feeding distance of the feeding device;

obtaining a route target point according to the positioning information of the first set of vertices and the route planning point;

dividing the route target point into an unreached target point or a reached target point according to the positioning information of the unmanned ship and the route target point; and

obtaining a cruise route according to the positioning information of the unmanned ship and the unreached target point.

Further, the establishing the regional model according to the positioning information of the first set of vertices, and obtaining the route planning point according to the regional model and the feeding distance of the feeding device includes:

obtaining a maximum longitude value, a minimum longitude value, a maximum latitude value and a minimum latitude value according to the positioning information of the first set of vertices;

establishing the regional model and obtaining positioning information of a second set of vertices of the regional model according to the maximum longitude value, the minimum longitude value, the maximum latitude value and the minimum latitude value; and

obtaining the route planning point according to the feeding distance of the feeding device and the positioning information of the second set of vertices.

Further, the obtaining the route planning point according to the feeding distance of the feeding device and the positioning information of the second set of vertices includes:

obtaining a transverse length and a longitudinal length by using a longitude and latitude length conversion formula according to the positioning information of the second set of vertices;

obtaining a number of transverse planning points according to the transverse length and the feeding distance of the feeding device, and obtaining a number of longitudinal planning points according to the longitudinal length and the feeding distance of the feeding device;

obtaining a longitude difference value by using a transverse longitude difference value formula according to the positioning information of the second set of vertices and the number of the transverse planning points;

obtaining a latitude difference value by using a longitudinal latitude difference value formula according to the positioning information of the second set of vertices and the number of the longitudinal planning points; and

obtaining the route planning point according to the positioning information of the second set of vertices, the number of the transverse planning points, the number of the longitudinal planning points, the longitude difference value and the latitude difference value.

Further, the obtaining the number of the transverse planning points according to the transverse length and the feeding distance of the feeding device, and obtaining the number of the longitudinal planning points according to the longitudinal length and the feeding distance of the feeding device includes:

dividing the transverse length by the feeding distance of the feeding device to obtain a transverse remainder;

dividing the longitudinal length by the feeding distance of the feeding device to obtain a longitudinal remainder;

if the transverse remainder is 0, obtaining the number of the transverse planning points by using a first transverse number formula; otherwise, obtaining the number of the transverse planning points by using a second transverse number formula; and

if the longitudinal remainder is 0, obtaining the number of the longitudinal planning points by using a first longitudinal number formula; otherwise, obtaining the number of the longitudinal planning points by using a second longitudinal number formula.

Further, the obtaining the route planning point according to the positioning information of the second set of vertices, the number of the transverse planning points, the number of the longitudinal planning points, the longitude difference value and the latitude difference value includes:

taking any vertex in the second set of vertices as an initial vertex according to the positioning information of the second set of vertices to obtain an initial planning point, wherein a transverse coordinate of the initial planning point differs from the initial vertex by a half of the longitude difference value, a longitudinal coordinate of the initial planning point differs from the initial vertex by a half of the latitude difference value, and the initial planning point is located in the regional model;

obtaining calculating times of the transverse coordinate according to the number of the transverse planning points;

obtaining a set of transverse coordinates according to the initial planning point, the calculating times of the transverse coordinate and the longitude difference value, wherein adjacent coordinate values of the set of transverse coordinates all differ by the longitude difference value;

obtaining calculating times of the longitudinal coordinate according to the number of the longitudinal planning points;

obtaining a set of longitudinal coordinates according to the initial planning point, the calculating times of the longitudinal coordinate and the latitude difference value, wherein adjacent coordinate values of the set of longitudinal coordinates all differ by the latitude difference value; and

obtaining the route planning point according to the initial planning point, the set of transverse coordinates and the set of longitudinal coordinates.

Further, the obtaining the route target point according to the positioning information of the first set of vertices and the route planning point includes:

obtaining a set of route vectors according to the positioning information of the first set of vertices and the route planning point;

obtaining an angle sum of adjacent vectors by using a vector angle formula according to the set of route vectors; and

dividing the route planning point into the route target point or a traffic prohibited point according to the angle sum of the adjacent vectors.

Further, dividing the route target point into the unreached target point or the reached target point according to the positioning information of the unmanned ship and the route target point includes:

obtaining a judgment region circle according to the route target point, wherein a center of the judgment region circle is the route target point, and a radius of the judgment region circle is the minimum one of ⅓ of the longitude difference value and ⅓ of the latitude difference value;

obtaining a shortest distance between the unmanned ship and the route target point according to the positioning information of the unmanned ship and the route target point, and recording the route target point closest to the unmanned ship as a nearest target point; and

dividing the route target point into the unreached target point or reached target point according to the shortest distance and a size of the radius of the judgment region circle.

Further, the obtaining the cruise route according to the positioning information of the unmanned ship and the unreached target point includes:

setting number of iterations, and randomly arranging the unreached target points according to the number of iterations to obtain a plurality of corresponding sequential route point arrays;

taking two adjacent unreached target points in the sequential route point arrays, and obtaining a distance between the two points by using a distance formula;

obtaining total route lengths traversed by using an accumulation formula according to the sequential route point arrays and the distance between the two points;

comparing the total route lengths to obtain the shortest total route length, and recording the corresponding sequential route point array as an optimal route point array; and

obtaining the cruise route according to the optimal route point array.

On the second aspect, the present disclosure provides a dynamic route planning device for unmanned ship used for feeding, which includes:

at least one control processor and a memory in communication connection with the at least one control processor, wherein the memory stores an instruction executable by the at least one control processor, and the instruction is executed by the at least one control processor, so that the at least one control processor is able to execute the above dynamic route planning method for unmanned ship used for feeding.

On the third aspect, the present disclosure provides a computer-readable storage medium, wherein the computer-readable storage medium stores a computer-executable instruction, and the computer-executable instruction is used for enabling a computer to execute the above dynamic route planning method for unmanned ship used for feeding.

On the fifth aspect, the present disclosure further provides a computer program product, wherein the computer program product includes a computer program stored on the computer-readable storage medium, the computer program includes a program instruction, and when the program instruction is executed by a computer, the computer executes the above dynamic route planning method for unmanned ship used for feeding.

One or more technical solutions provided in the embodiments of the present disclosure have at least the following beneficial effects: the present disclosure provides the dynamic route planning method and device for unmanned ship used for feeding, the route target point is determined according to the vertex of the water body region and the feeding distance of the feeding device, then the reached target point that has been cruised is recorded, the unreached target point is determined, and the cruise route with the shortest distance is dynamically generated during cruising, so that the unmanned ship is able to travel according to a currently optimal cruise route after deviating from the preset cruise route due to various factors, and perform completely covered feeding, thus improving an output and a benefit.

### BRIEF DESCRIPTION OF THE DRAWINGS

The present disclosure is further described hereinafter with reference to the accompanying drawings and the embodiments.

FIG. 1 is a flow chart of a dynamic route planning method for unmanned ship used for feeding provided in a first embodiment of the present disclosure;

FIG. 2 is a flow chart of a specific method of step S200 in the dynamic route planning method for unmanned ship used for feeding provided in a first embodiment of the present disclosure;

FIG. 3 is a flow chart of a specific method of step S230 in the dynamic route planning method for unmanned ship used for feeding provided in a first embodiment of the present disclosure;

FIG. 4 is a flow chart of a specific method of step S232 in the dynamic route planning method for unmanned ship used for feeding provided in a first embodiment of the present disclosure;

FIG. 5 is a flow chart of a specific method of step S235 in the dynamic route planning method for unmanned ship used for feeding provided in a first embodiment of the present disclosure;

FIG. 6 is a flow chart of a specific method of step S300 in the dynamic route planning method for unmanned ship used for feeding provided in a first embodiment of the present disclosure;

FIG. 7 is a flow chart of a specific method of step S400 in the dynamic route planning method for unmanned ship used for feeding provided in a first embodiment of the present disclosure;

FIG. 8 is a flow chart of a specific method of step S500 in the dynamic route planning method for unmanned ship used for feeding provided in a first embodiment of the present disclosure;

FIG. 9 is a flow chart of generation of a cruise route in the dynamic route planning method for unmanned ship used for feeding provided in a first embodiment of the present disclosure; and

FIG. 10 is a structure diagram of a dynamic route planning device for unmanned ship used for feeding provided in the second embodiment of the present disclosure.

100 refers to dynamic route planning device for unmanned ship used for feeding, 110 refers to control processor and 120 refers to memory.

### DETAILED DESCRIPTION

To make the objectives, the technical solutions, and the advantages of the present disclosure clearer, the present disclosure is further described in detail hereinafter with reference to the accompanying drawings and the embodiments. It should be understood that the specific embodiments described herein are only used for explaining the present disclosure and are not intended to limit the present disclosure.

It should be noted that, the various features in the embodiments of the present disclosure may be combined with each other if there is no conflict, and the features are all included in the scope of protection of the present disclosure. In addition, although the functional modules are divided in the apparatus diagram and the logical sequence is shown in the flow chart, the steps shown or described may be performed according to different module division in the apparatus or different sequence in the flow chart in some cases.

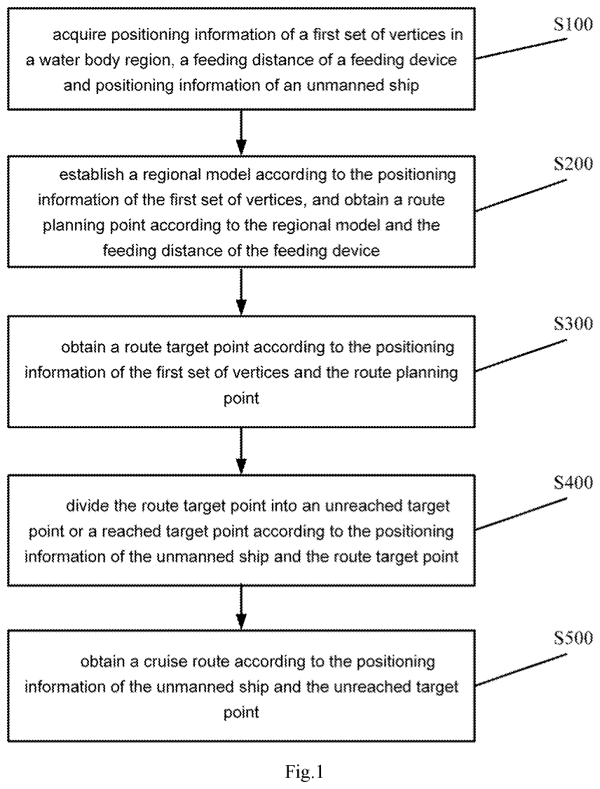

In a first embodiment of the present disclosure, a flow chart of a dynamic route planning method for unmanned ship used for feeding is shown in FIG. 1, and the method may also be executed by a dynamic route planning device for unmanned ship used for feeding. The method includes:

S100. acquiring positioning information of a first set of vertices in a water body region, a feeding distance of a feeding device and positioning information of an unmanned ship;

S200. establishing a regional model according to the positioning information of the first set of vertices, and obtaining a route planning point according to the regional model and the feeding distance of the feeding device;

S300. obtaining a route target point according to the positioning information of the first set of vertices and the route planning point;

S400. dividing the route target point into an unreached target point or a reached target point according to the positioning information of the unmanned ship and the route target point; and

S500. obtaining a cruise route according to the positioning information of the unmanned ship and the unreached target point.

In specific practice, a positioning device such as a GPS or a Beidou is used to obtain the positioning information of the first set of vertices in the water body region. A number of first vertices in the water body region is determined first, and then latitude and longitude coordinates of the first vertices are acquired. According to the number N of the first vertices, a 2×N array bPoint[ ][ ] is established, and then the corresponding longitude and latitude coordinates (bLng(n), bLat(n)) of each vertex are acquired. The longitude coordinates bLng(n) are correspondingly recorded to bPoint[0][n] in sequence, and the latitude coordinates bLat (n) are correspondingly recorded to bPoint[1][n] in sequence, so as to establish the regional model of the water body region. The feeding distance of the feeding device is obtained from a specification of the feeding device, and the route planning point is obtained by analysis in combination with the regional model of the water body region. The route target point is obtained in combination with the route planning point according to positioning information of the first vertices. The positioning information of the unmanned ship is acquired by using the positioning device such as the GPS or the Beidou, the route target point that the unmanned ship passes through is marked as the reached target point, and the route target point that the unmanned ship does not pass through is marked as the unreached target point. The optimal cruise route is obtained by analysis according to the unreached target point or a position of the unmanned ship.

It can be understood that a shape of the water body region is generally a convex polygon with multiple vertices, and all vertices of the water body region form the first set of vertices. The route target point is determined according to the first set of vertices of the water body region and the feeding distance of the feeding device, then the reached target point that has been cruised is recorded, and the unreached target point is determined. The cruise route with the shortest distance is dynamically generated during cruising, so that the unmanned ship is able to travel according to a currently optimal cruise route after deviating from the preset cruise route due to various factors, and perform completely covered feeding, thus improving an output and a benefit.

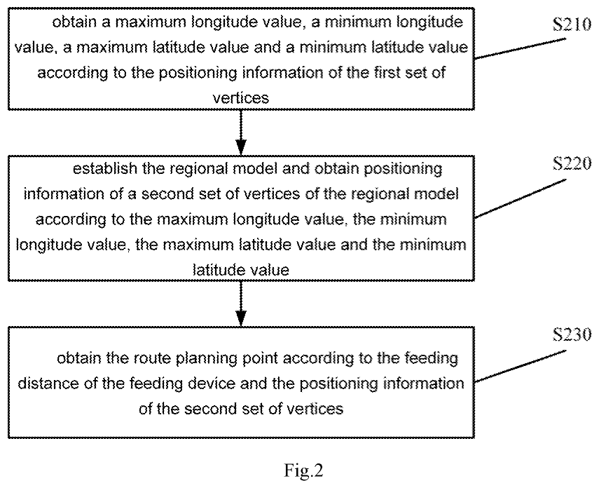

As shown in FIG. 2, the step S200 includes:

S210. obtaining a maximum longitude value, a minimum longitude value, a maximum latitude value and a minimum latitude value according to the positioning information of the first set of vertices;

S220. establishing the regional model and obtaining positioning information of a second set of vertices of the regional model according to the maximum longitude value, the minimum longitude value, the maximum latitude value and the minimum latitude value; and

S230. obtaining the route planning point according to the feeding distance of the feeding device and the positioning information of the second set of vertices.

In specific practice, the maximum longitude value lngMax, the minimum longitude value lngMin, the maximum latitude value latMax and the minimum latitude value latMin are acquired from the array bPoint[ ][ ], and (lngMax, latMax), (lngMax, latMin), (lngMin, latMax) and (lngMin, latMin) are used as four vertices to establish a rectangular regional model. The route planning point is obtained by analysis in the regional model according to the feeding distance of the feeding device.

It can be understood that the rectangular regional model is easier to be used in mathematical analysis. A regional model of a bounding rectangle may be obtained according to the positioning information of the first set of vertices, the rectangular regional model has four vertices, and the four vertices form the second set of vertices. The route planning point is obtained according to the feeding distance of the feeding device, so that the water body region may be completely covered during feeding after the unmanned ship passes through the route planning point obtained by analysis, thus ensuring an output and a benefit of production.

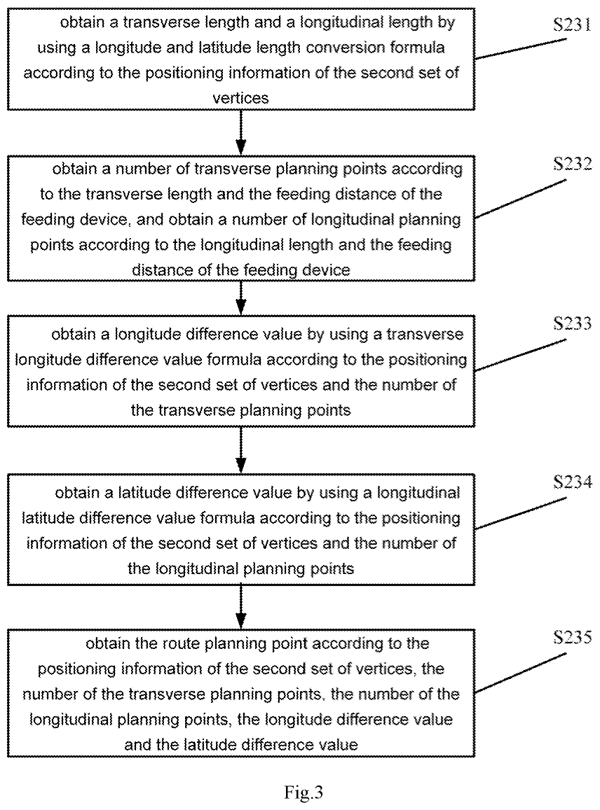

As shown in FIG. 3, the step S230 includes:

S231. obtaining a transverse length and a longitudinal length by using a longitude and latitude length conversion formula according to the positioning information of the second set of vertices;

S232. obtaining a number of transverse planning points according to the transverse length and the feeding distance of the feeding device, and obtaining a number of longitudinal planning points according to the longitudinal length and the feeding distance of the feeding device;

S233. obtaining a longitude difference value by using a transverse longitude difference value formula according to the positioning information of the second set of vertices and the number of the transverse planning points;

S234. obtaining a latitude difference value by using a longitudinal latitude difference value formula according to the positioning information of the second set of vertices and the number of the longitudinal planning points; and

S235. obtaining the route planning point according to the positioning information of the second set of vertices, the number of the transverse planning points, the number of the longitudinal planning points, the longitude difference value and the latitude difference value.

In specific practice, the transverse longitude difference value formula is as follows:

Dₓ=(lngMax−lngMin)/(Mₓ+1),

wherein Dₓ is the longitude difference value, lngMax is the maximum longitude value, lngMin is the minimum longitude value, and Mₓ is the number of the transverse planning points.

The longitudinal latitude difference value formula is as follows:

D_{y}=(latMax−latMin)/(M_{y}+1),

wherein D_{y} is the latitude difference value, lngMax is the maximum latitude value, lngMin is the minimum latitude value, and M_{y} is the number of the longitudinal planning points.

It can be understood that the number of the transverse planning points and the number of the longitudinal planning points are obtained by using corresponding formulas, so as to obtain the longitude difference value and the latitude difference value, and then the route planning point is obtained, ensuring an effectiveness of generation of the route planning point, so that the water body region may be completely covered during feeding after the unmanned ship passes through the route planning point obtained by analysis, thus ensuring the output and the benefit of production.

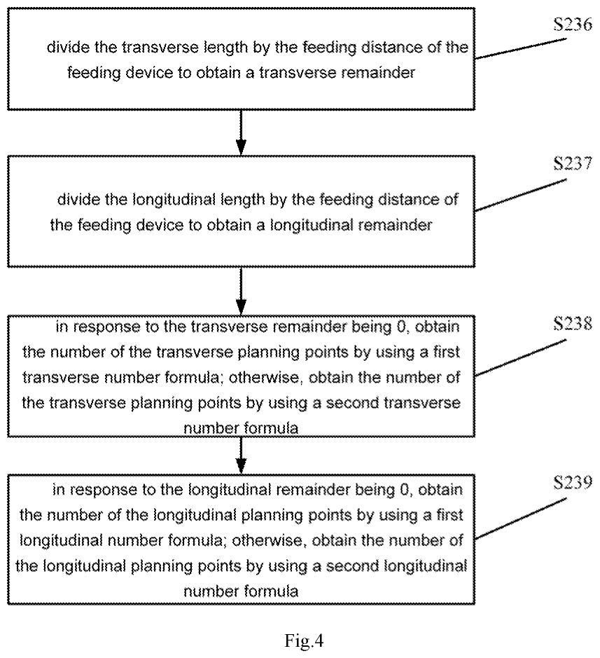

As shown in FIG. 4, the step S232 includes:

S236. dividing the transverse length by the feeding distance of the feeding device to obtain a transverse remainder;

S237. dividing the longitudinal length by the feeding distance of the feeding device to obtain a longitudinal remainder;

S238. in response to the transverse remainder being 0, obtaining the number of the transverse planning points by using a first transverse number formula; otherwise, obtaining the number of the transverse planning points by using a second transverse number formula; and

S239. in response to the longitudinal remainder being 0, obtaining the number of the longitudinal planning points by using a first longitudinal number formula; otherwise, obtaining the number of the longitudinal planning points by using a second longitudinal number formula.

In specific practice, the first transverse number formula is: Mₓ=Sₓ/L, and the second transverse number formula is: Mₓ=Sₓ/L+1,

wherein Mₓ is the number of the transverse planning points, S, is the transverse length, and L is the feeding distance of the feeding device.

The first longitudinal number formula is: M_{y}=S_{y}/L, and the second longitudinal number formula is: M_{y}=S_{y}/L+1,

wherein M_{y} is the number of the longitudinal planning points, S_{y} is the longitudinal length, and L is the feeding distance of the feeding device.

It can be understood that when the transverse remainder is 0, the number of the transverse planning points is obtained by using the first the transverse number formula, and full coverage of transverse feeding may be ensured at the moment. When the transverse remainder is not 0, a result of dividing the transverse length by the feeding distance of the feeding device needs to be added with one, the number of the transverse planning points is obtained by using the second transverse number formula, and the full coverage of the transverse feeding may be ensured at the moment. In the same way, the number of the longitudinal planning points is obtained by using the first longitudinal number formula or the second longitudinal number formula, and full coverage of longitudinal feeding may be ensured at the moment.

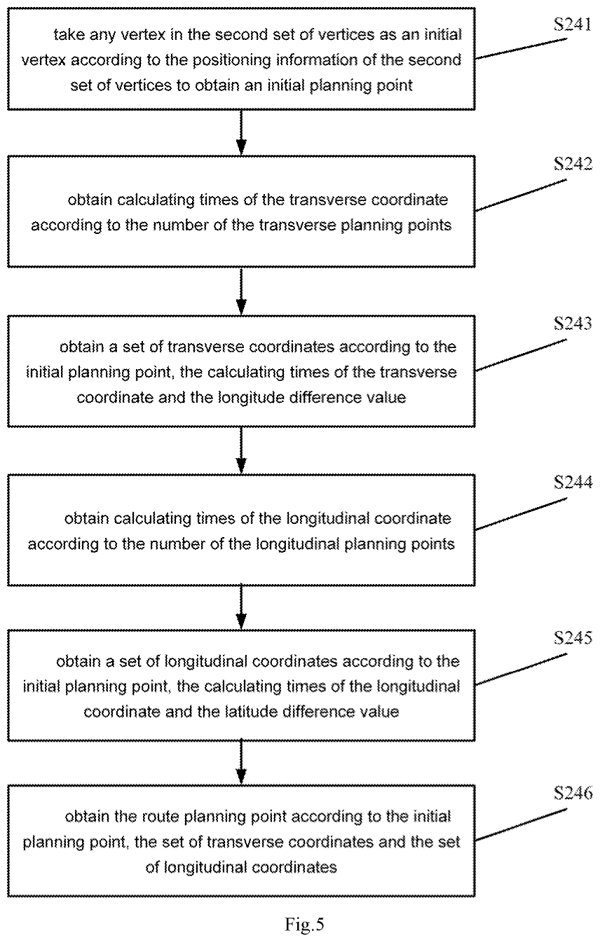

As shown in FIG. 5, the step S235 includes:

S241. taking any vertex in the second set of vertices as an initial vertex according to the positioning information of the second set of vertices to obtain an initial planning point, wherein a transverse coordinate of the initial planning point differs from the initial vertex by a half of the longitude difference value, a longitudinal coordinate of the initial planning point differs from the initial vertex by a half of the latitude difference value, and the initial planning point is located in the regional model;

S242. obtaining calculating times of the transverse coordinate according to the number of the transverse planning points;

S243. obtaining a set of transverse coordinates according to the initial planning point, the calculating times of the transverse coordinate and the longitude difference value, wherein adjacent coordinate values of the set of transverse coordinates all differ by the longitude difference value;

S244. obtaining calculating times of the longitudinal coordinate according to the number of the longitudinal planning points;

S245. obtaining a set of longitudinal coordinates according to the initial planning point, the calculating times of the longitudinal coordinate and the latitude difference value, wherein adjacent coordinate values of the set of longitudinal coordinates all differ by the latitude difference value; and

S246. obtaining the route planning point according to the initial planning point, the set of transverse coordinates and the set of longitudinal coordinates.

It can be understood that a distance between the route planning point near a boundary of water body region and the boundary is only a half of a distance between two route planning points. Therefore, an increment of the longitude coordinate of the initial planning point is only a half of the longitude difference value, and an increment of the latitude coordinate is only a half of the latitude difference value. According to the number of the transverse planning points and the number of the longitudinal planning points, the route planning points of the longitude difference value and the latitude difference value differed are obtained in sequence starting from the initial planning point to ensure a uniformity and an effectiveness of the route planning points, thus ensuring an effectiveness of the cruise route.

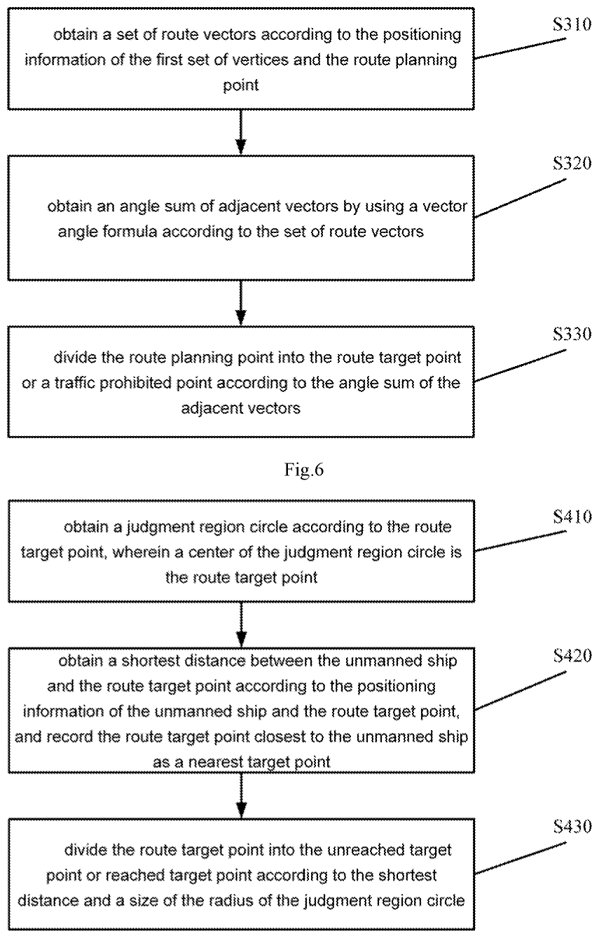

As shown in FIG. 6, the step S300 includes:

S310. obtaining a set of route vectors according to the positioning information of the first set of vertices and the route planning point;

S320. obtaining an angle sum of adjacent vectors by using a vector angle formula according to the set of route vectors; and

S330. dividing the route planning point into the route target point or a traffic prohibited point according to the angle sum of the adjacent vectors.

In specific practice, the array bPoint[ ][ ] is used to record a coordinate of the first vertex of the water body region, and a 2×N array pVrctor[ ][ ] is established according to the number N of the route planning points by formulas as follows:

vLng=bLng−pLng, and vLat=bLat−pLat,

wherein bLng is the longitude value of the coordinate of the first vertex, pLng is the longitude value of the route planning point, bLat is the latitude value of the coordinate of the first vertex, and pLat is the latitude value of the route planning point.

Each route planning point and vectors (vLng, vLat) of the first vertex of the water body region are obtained by calculation, and the vectors (vLng, vLat) are recorded in the pVrcotor [ ][ ] in sequence according to vectors in the pVrcotor [symbol] [ ] by the vector angle formula as follows:

$$θ z = arccos ( \frac{\begin{matrix}vLng ( n + 1 ) \times vLng ( n ) + \\ vLat ( n + 1 ) \times vLat ( n )\end{matrix}}{\begin{matrix}\sqrt{{( vLng ( n + 1 ) )}^{2} + {( vLat ( n + 1 ) )}^{2} +} \\ \sqrt{{( vLng ( n ) )}^{2} + {( vLat ( n ) )}^{2}}\end{matrix}} ) .$$

wherein θz is an included angle between two adjacent vectors.

The included angle θz of every two adjacent vectors is obtained by calculation, and all the included angles θz are added to obtain θ. According to an angle sum method, if the angle sum θ is equal to 27, the route planning point is determined to be in the water body region, and the route planning point is recorded as the route target point, otherwise the route planning point is recorded as the traffic prohibited point.

It can be understood that when the water body region is not rectangular, a region of the regional model established according to the first vertices is larger than the water body region. The route planning point is generated according to the regional model, and the route planning point located outside the water body region is unable to be passed through. According to the angle sum method, whether the route planning point is located in the water body region is able to be determined, and all the route target points are ensured to be found by using the angle sum method, thus ensuring the effectiveness of the cruise route.

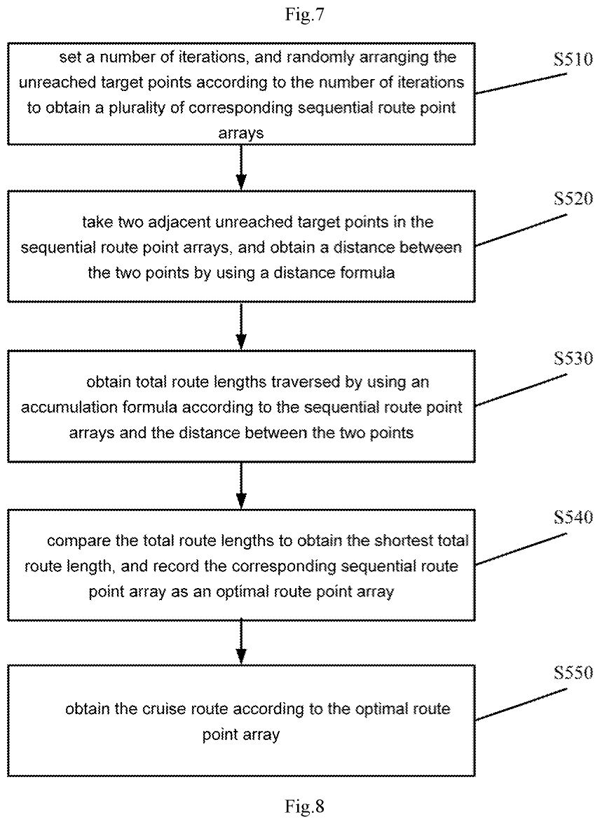

As shown in FIG. 7, the step S400 includes:

S410. obtaining a judgment region circle according to the route target point, wherein a center of the judgment region circle is the route target point, and a radius of the judgment region circle is the minimum one of ⅓ of the longitude difference value and ⅓ of the latitude difference value;

S420. obtaining a shortest distance between the unmanned ship and the route target point according to the positioning information of the unmanned ship and the route target point, and recording the route target point closest to the unmanned ship as a nearest target point; and

S430. dividing the route target point into the unreached target point or reached target point according to the shortest distance and a size of the radius of the judgment region circle.

It can be understood that each route target point has the corresponding judgment region circle, and the minimum one of ⅓ of the longitude difference value and ⅓ of the latitude difference value is used as the radius of the judgment region circle. The route target point closest to the unmanned ship is determined as the nearest target point according to a position of the unmanned ship, and the shortest distance is obtained. When the shortest distance is less than the radius of the judgment region circle, the current nearest target point is determined to be the reached target point, otherwise the current nearest target point is the unreached target point. The radius is determined according to ⅓ of the difference value, which may effectively ensure the full coverage of the unmanned ship feeding, thus ensuring the output and the benefit.

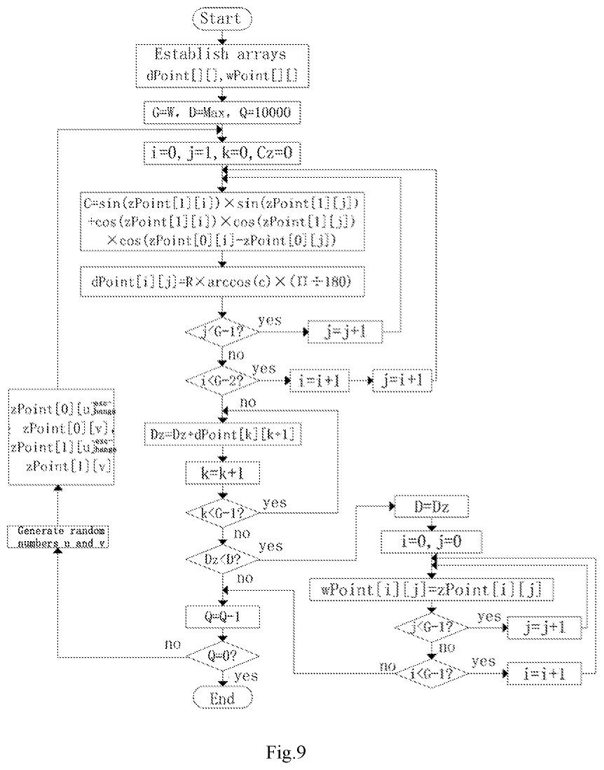

As shown in FIG. 8 to FIG. 9, the step S500 includes:

S510. Setting a number of iterations, and randomly arranging the unreached target points according to the number of iterations to obtain a plurality of corresponding sequential route point arrays;

S520. taking two adjacent unreached target points in the sequential route point arrays, and obtaining a distance between the two points by using a distance formula;

S530. obtaining total route lengths traversed by using an accumulation formula according to the sequential route point arrays and the distance between the two points;

S540. comparing the total route lengths to obtain the shortest total route length, and recording the corresponding sequential route point array as an optimal route point array; and

S550. obtaining the cruise route according to the optimal route point array.

In specific practice, the distance formula is as follows:

C=sin(zLat(i))*sin(zLat(j))+cos(zLat(i))*cos(zLat(j))*cos(zLng(i)−zLng(j)),

H(ij)=R*arccos(C)*π/180,

wherein zLat(i) is a latitude value of an unreached target point i, zLng(i) is a longitude value of the unreached target point i, zLat(j) is a latitude value of an unreached target point j, zLng(j) is a longitude value of the unreached target pointj, R is a radius of the earth, and H(ij) is the distance between the two points.

The accumulation formula is as follows:

Dz=H(12)+ . . . H(23)++H((W−2)(W−1)),

wherein W is the number of the unreached target points, and Dz is the total route length.

A 2×W sequential route point array zPoint [symbol] [symbol] is established, and the unreached target points (zing (n), zlat (n)) which are arranged in sequence are stored. A large enough number Max is taken to make the total route length be D=Max, the number of iterations are set as Q=10000, a W×W array dPoint [symbol] [symbol] is established according to the number W of the unreached target points, and the distance H(ij) between two adjacent unreached target points is calculated by using the distance formula, and recorded in the array dPoint [symbol] [symbol] . The total route lengths are obtained by using the accumulation formula. A 2×W array wPoint [symbol] [symbol] is established for storing an arrangement sequence of the unreached target points in the case of the shortest total route length. A number of the remaining route target points is recorded as G, and G=W at initial time. Whether the total route length Dz generated each time is smaller than the total route length D stored is determined, if the total route length Dz is smaller than the total route length D, then D=Dz, the zPoint [symbol] [symbol] is assigned to the wPoint [symbol] [symbol] in a one-to-one correspondence manner, and then the number of iterations Q are reduced by one; and if the total route length Dz is not smaller than the total route length D, the number of iterations Q are directly reduced by one. Random numbers u and v which are less than the number G of the remaining route target points are generated, sequences in zPoint [symbol] [u] and zPoint [symbol] [v] are exchanged, and then calculation is performed again until the number of iterations Q are 0. Finally, the coordinates of the route target points in a specific sequence are stored in the wPoint [symbol] [symbol] , the wPoint [symbol] [symbol] is the optimal route point array, and the cruise route is obtained according to the optimal route point array.

It can be understood that the shortest total route length is obtained according to the unreached target point updated in real time, and the corresponding sequential route point array is obtained, so that the optimal cruise route updated in real time is obtained, thus ensuring a real-time performance and the effectiveness of the cruise route. Therefore, the unmanned ship is able to move according to the currently optimal cruise route after deviating from the preset cruise route due to various factors, and perform complete coverage feeding, thus improving the output and the benefit.

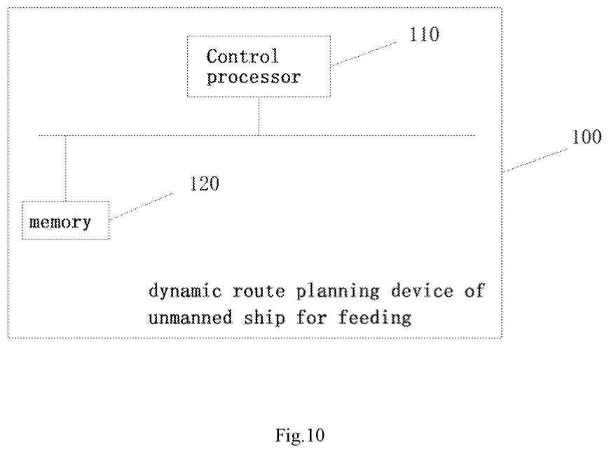

In the second embodiment of the present disclosure, a dynamic route planning device for unmanned ship used for feeding 100 is shown in FIG. 10, and the dynamic route planning device for unmanned ship used for feeding 100 may be any type of intelligent terminal, such as a mobile phone, a tablet computer, a personal computer, and the like.

Specifically, the dynamic route planning device for unmanned ship used for feeding 100 includes: one or more control processors 110 and a memory 120. One control processor 110 is taken as an example in FIG. 10.

The control processor 110 and the memory 120 may be connected by a bus or other modes. Connection by the bus is taken as an example in FIG. 10.

The memory 120 is used as a non-transient computer-readable storage medium, and may be used for storing a non-transient software program, a non-transient computer-executable program and a module, such as a program instruction/module corresponding to the dynamic route planning method for unmanned ship used for feeding in the embodiment of the present disclosure, such as a receiving module 110 and a processing module 120 shown in FIG. 10. The control processor 110 implements the dynamic route planning method for unmanned ship used for feeding in the above method embodiment by operating the non-transient software program, instruction and module stored in the memory 120.

The memory 120 may include a stored program area and a stored data area, wherein the stored program area may store an application program required by at least one function of an operating system, and the stored data area may store and use data created, and the like. In addition, the memory 120 may include a high-speed random access memory, and may also include a non-transient memory, such as at least one disk memory device, flash memory device, or other non-transient solid-state memory devices. In some embodiments, the memory 120 may optionally include a memory remotely arranged relative to the control processor 110, and these remote memories may be connected to the dynamic route planning device for unmanned ship used for feeding 100 through a network. Examples of the above network include but are not limited to the Internet, the intranet, the local area network, the mobile communication network and a combination thereof.

One or more modules are stored in the memory 120, and when the modules are executed by one or more control processors 110, the dynamic route planning method for unmanned ship used for feeding in the above method embodiments is executed, such as executing the method steps S100 to S500 in FIG. 1, the method steps S210 to S230 in FIG. 2, the method steps S231 to S235 in FIG. 3, the method steps S236 to S237 in FIG. 4, the method steps S241 to S246 in FIG. 5, the method steps S310 to S330 in FIG. 6, the method steps S410 to S430 in FIG. 7, and the method steps S510 to S550 in FIG. 8 in the above description.

The embodiment of the present disclosure further provides a computer-readable storage medium, the computer-readable storage medium stores a computer-executable instruction, and the computer-executable instruction is executed by one or more control processors 110. For example, when the computer-executable instruction is executed by one control processor 110 in FIG. 10, the above one or more control processors 110 may execute the dynamic route planning method for unmanned ship used for feeding in the above method embodiments, such as executing the steps S100 to S500 in FIG. 1, the steps S210 to S230 in FIG. 2, the steps S231 to S235 in FIG. 3, the steps S236 to S237 in FIG. 4, the steps S241 to S246 in FIG. 5, the steps S310 to S330 in FIG. 6, the steps S410 to S430 in FIG. 7, and the steps S510 to S550 in FIG. 8 in the above description.

The apparatus embodiment described above is only illustrative, wherein the units described as separated components may or may not be physically separated, which means that the units may be located in one place or distributed to multiple network units. Some or all of the modules may be selected according to actual needs to achieve the objectives of the solutions in the embodiments.

From the description of the above embodiments, those skilled in the art may clearly understand that each embodiment may be realized by means of software with a general hardware platform. Those skilled in the art may understand that all or partial flows in the method for realizing the above embodiments may be completed by instructing related hardware through a computer program, and the program may be stored in a computer-readable storage medium. The flows of the above method embodiment may be included when the program is executed. The storage medium may be a magnetic disk, an optical disk, a Read Only Memory (ROM), a Random Access Memory (RAM), or the like.

The foregoing describes the preferred embodiments of the present disclosure in detail, but the present disclosure is not limited to the above embodiments. Those skilled in the art may further make various equivalent modifications or substitutions without violating the spirit of the present disclosure, and these equivalent modifications or substitutions are included in the scope defined by the claims of the present application.

We claim:

1. A dynamic route planning method for unmanned ship used for feeding, comprising:
acquiring positioning information of a first set of vertices in a water body region, a feeding distance of a feeding device and positioning information of an unmanned ship;
establishing a regional model according to the positioning information of the first set of vertices, and obtaining a route planning point according to the regional model and the feeding distance of the feeding device;
obtaining route target points according to the positioning information of the first set of vertices and the route planning point;
dividing the route target points into an unreached target point or a reached target point according to the positioning information of the unmanned ship and the route target point; and
obtaining a cruise route according to the positioning information of the unmanned ship and the unreached target point.

2. The dynamic route planning method for unmanned ship used for feeding of claim 1, wherein establishing a regional model according to the positioning information of the first set of vertices, and obtaining a route planning point according to the regional model and the feeding distance of the feeding device comprises:
obtaining a maximum longitude value, a minimum longitude value, a maximum latitude value and a minimum latitude value according to the positioning information of the first set of vertices;
establishing the regional model and obtaining positioning information of a second set of vertices of the regional model according to the maximum longitude value, the minimum longitude value, the maximum latitude value and the minimum latitude value; and
obtaining the route planning point according to the feeding distance of the feeding device and the positioning information of the second set of vertices.

3. The dynamic route planning method for unmanned ship used for feeding of claim 2, wherein obtaining the route planning point according to the feeding distance of the feeding device and the positioning information of the second set of vertices comprises:
obtaining a transverse length and a longitudinal length by using a longitude and latitude length conversion formula according to the positioning information of the second set of vertices;
obtaining a number of transverse planning points according to the transverse length and the feeding distance of the feeding device, and obtaining a number of longitudinal planning points according to the longitudinal length and the feeding distance of the feeding device;
obtaining a longitude difference value by using a transverse longitude difference value formula according to the positioning information of the second set of vertices and the number of the transverse planning points;
obtaining a latitude difference value by using a longitudinal latitude difference value formula according to the positioning information of the second set of vertices and the number of the longitudinal planning points; and
obtaining the route planning point according to the positioning information of the second set of vertices, the number of the transverse planning points, the number of the longitudinal planning points, the longitude difference value and the latitude difference value.

4. The dynamic route planning method for unmanned ship used for feeding of claim 3, wherein obtaining a number of transverse planning points according to the transverse length and the feeding distance of the feeding device, and obtaining a number of longitudinal planning points according to the longitudinal length and the feeding distance of the feeding device comprises:
dividing the transverse length by the feeding distance of the feeding device to obtain a transverse remainder;
dividing the longitudinal length by the feeding distance of the feeding device to obtain a longitudinal remainder;
in response to the transverse remainder being 0, obtaining the number of the transverse planning points by using a first transverse number formula; otherwise, obtaining the number of the transverse planning points by using a second transverse number formula; and
in response to the longitudinal remainder being 0, obtaining the number of the longitudinal planning points by using a first longitudinal number formula; otherwise, obtaining the number of the longitudinal planning points by using a second longitudinal number formula.

5. The dynamic route planning method for unmanned ship used for feeding of claim 3, wherein obtaining the route planning point according to the positioning information of the second set of vertices, the number of the transverse planning points, the number of the longitudinal planning points, the longitude difference value and the latitude difference value comprises:
taking any vertex in the second set of vertices as an initial vertex according to the positioning information of the second set of vertices to obtain an initial planning point, wherein a transverse coordinate of the initial planning point differs from the initial vertex by a half of the longitude difference value, a longitudinal coordinate of the initial planning point differs from the initial vertex by a half of the latitude difference value, and the initial planning point is located in the regional model;
obtaining calculating times of the transverse coordinate according to the number of the transverse planning points;
obtaining a set of transverse coordinates according to the initial planning point, the calculating times of the transverse coordinate and the longitude difference value, wherein adjacent coordinate values of the set of transverse coordinates all differ by the longitude difference value;
obtaining calculating times of the longitudinal coordinate according to the number of the longitudinal planning points;
obtaining a set of longitudinal coordinates according to the initial planning point, the calculating times of the longitudinal coordinate and the latitude difference value, wherein adjacent coordinate values of the set of longitudinal coordinates all differ by the latitude difference value; and
obtaining the route planning point according to the initial planning point, the set of transverse coordinates and the set of longitudinal coordinates.

6. The dynamic route planning method for unmanned ship used for feeding of claim 1, wherein obtaining route target points according to the positioning information of the first set of vertices and the route planning point comprises:
obtaining a set of route vectors according to the positioning information of the first set of vertices and the route planning point;
obtaining an angle sum of adjacent vectors by using a vector angle formula according to the set of route vectors; and
dividing the route planning point into the route target point or a traffic prohibited point according to the angle sum of the adjacent vectors.

7. The dynamic route planning method for unmanned ship used for feeding of claim 5, wherein dividing the route planning point into the route target point or a traffic prohibited point according to the angle sum of the adjacent vectors comprises:
obtaining a judgment region circle according to the route target point, wherein a center of the judgment region circle is the route target point, and a radius of the judgment region circle is the minimum one of ⅓ of the longitude difference value and ⅓ of the latitude difference value;
obtaining a shortest distance between the unmanned ship and the route target point according to the positioning information of the unmanned ship and the route target point, and recording the route target point closest to the unmanned ship as a nearest target point; and
dividing the route target point into the unreached target point or reached target point according to the shortest distance and a size of the radius of the judgment region circle.

8. The dynamic route planning method for unmanned ship used for feeding of claim 1, wherein obtaining a cruise route according to the positioning information of the unmanned ship and the unreached target point comprises:
setting a number of iterations, and randomly arranging the unreached target points according to the number of iterations to obtain a plurality of corresponding sequential route point arrays;
taking two adjacent unreached target points in the sequential route point arrays, and obtaining a distance between the two points by using a distance formula;
obtaining total route lengths traversed by using an accumulation formula according to the sequential route point arrays and the distance between the two points;
comparing the total route lengths to obtain the shortest total route length, and recording the corresponding sequential route point array as an optimal route point array; and
obtaining the cruise route according to the optimal route point array.

9. A dynamic route planning device for unmanned ship used for feeding, comprising:
at least one processor; and
a memory in communication connection with the at least one processor; wherein,
the memory stores an instruction executable by the at least one processor, and the instruction is executed by the at least one processor, so that the at least one processor is able to execute a dynamic route planning method for unmanned ship used for feeding, the method comprising:
acquiring positioning information of a first set of vertices in a water body region, a feeding distance of a feeding device and positioning information of an unmanned ship;
establishing a regional model according to the positioning information of the first set of vertices, and obtaining a route planning point according to the regional model and the feeding distance of the feeding device;
obtaining route target points according to the positioning information of the first set of vertices and the route planning point;
dividing the route target points into an unreached target point or a reached target point according to the positioning information of the unmanned ship and the route target point; and
obtaining a cruise route according to the positioning information of the unmanned ship and the unreached target point.

10. A computer-readable storage medium, wherein the computer-readable storage medium stores a computer-executable instruction, and the computer-executable instruction is used for enabling a computer to execute a dynamic route planning method for unmanned ship used for feeding, the method comprising:
acquiring positioning information of a first set of vertices in a water body region, a feeding distance of a feeding device and positioning information of an unmanned ship;
establishing a regional model according to the positioning information of the first set of vertices, and obtaining a route planning point according to the regional model and the feeding distance of the feeding device;
obtaining route target points according to the positioning information of the first set of vertices and the route planning point;
dividing the route target points into an unreached target point or a reached target point according to the positioning information of the unmanned ship and the route target point; and
obtaining a cruise route according to the positioning information of the unmanned ship and the unreached target point.
